(19) United States
(12) Patent Application Publication
(10) Pub. No.: US 2013/0164208 A1
(43) Pub. Date: Jun. 27, 2013

(54) METHODS OF FORMING GRAPHENE

(71) Applicants: Yu-Tse HSIEH, Taoyuan County (TW); Kun-Ping HUANG, Miaoli County (TW); Pang LIN, Hsinchu City (TW)

(72) Inventors: Yu-Tse HSIEH, Taoyuan County (TW); Kun-Ping HUANG, Miaoli County (TW); Pang LIN, Hsinchu City (TW)

(21) Appl. No.: 13/548,651

(22) Filed: Jul. 13, 2012

(30) Foreign Application Priority Data
Dec. 27, 2011 (TW) 100148809

(51) Int. Cl. C01B 31/04; B82Y 40/00

(52) U.S. Cl. 423/448; 977/899

(57) ABSTRACT

Disclosed is a method of forming graphene. A graphite positive electrode (or positive electrode together with graphite material) wrapped in a semipermeable membrane and a negative electrode are dipped in an acidic electrolyte to conduct an electrolysis process. As such, a first graphene oxide having a size larger than a pore size of the semipermeable membrane is exfoliated from the graphite positive electrode (or the graphite material). The electrolysis process is continuously conducted until a second graphene oxide is exfoliated from the first graphene oxide, wherein the second graphene oxide has a size which is smaller than the pore size of the semipermeable membrane to penetrate through the semipermeable membrane. The second graphene oxide diffused into the acidic electrolyte outside of the semipermeable membrane is collected. Finally, the collected second graphene oxide is chemically reduced to obtain a graphene.

### CROSS REFERENCE TO RELATED APPLICATIONS

This Application claims priority of Taiwan Patent Application No. 100148809, filed on Dec. 27, 2011, the entirety of which is incorporated by reference herein.

### BACKGROUND OF THE INVENTION

1. Field of the Invention

The disclosure relates to a method of forming graphene, and in particular relates to electrolysis for forming the graphene.

2. Description of the Related Art

The topic of green energy grows in importance when fossil fuels begin to run out. Electricity and hydrogen storage research is a core research area of super capacitors and fuel cells. However, methods of obtaining electricity and hydrogen storage materials with high performance are currently at a bottleneck. A single atomic layer graphene having a theoretically specific capacity of 531 F/g, a theoretically hydrogen storage value of 6%, and a theoretically electrical conductivity of 10⁻⁶ Ω/cm may serve as an ideal electricity and hydrogen storage material.

In U.S. Pub. No. 2009/0026086A1, an organic compound of carboxylic acid is selected as an electrolyte. Graphite is firstly electrolyzed in the electrolyte, and then treated by hot-cold impact and mechanical shear, and then secondly electrolyzed in the electrolyte, such that the graphite is split to graphene fragments. However, a graphene of high yield cannot be formed by only electrolysis without other mechanical processes.

In U.S. Pub. No. 2011/0079748A1, graphene oxide is supersonic vibrated in a polypropylene carbonate solution to form a graphene oxide suspension. The graphene oxide suspension is heated at a temperature of 150° C. to obtain fragments of chemically reduced graphene oxide. However, the publication does not mention a graphene being prepared by electrolyzing graphite.

In U.S. Pub. No. 2008/0258359A1, an extensible material is used when electrolyzing graphite, such that an extensible material is inserted between graphite layers during electrolysis to initially split graphite. The split graphite is then thermally treated at a temperature of less than 650° C. and mechanically treated by a shear to form graphene fragments. Accordingly, a graphene of high yield cannot be formed by only electrolysis without other mechanical processes.

Therefore, a mass production method of forming graphene with high quality and high yield by only electrolysis without other mechanical processes is called-for.

### BRIEF SUMMARY OF THE INVENTION

One embodiment of the disclosure provides a method of forming graphene, comprising: wrapping a graphite positive electrode in a semipermeable membrane; dipping the graphite positive electrode wrapped in the semipermeable membrane and a negative electrode into an acidic electrolyte; conducting a electrolysis process, such that a first graphene oxide having a size larger than a pore size of the semipermeable membrane is exfoliated from the graphite positive electrode; continuously conducting the electrolysis process until a second graphene oxide is split from the first graphene oxide, wherein the second graphene oxide has a size which is smaller than the pore size of the semipermeable membrane to penetrate through the semipermeable membrane; collecting the second graphene oxide diffused into the acidic electrolyte outside of the semipermeable membrane; and chemically reducing the second graphene oxide to obtain a graphene.

One embodiment of the disclosure provides a method of forming graphene, comprising: wrapping a graphite material and a positive electrode in a semipermeable membrane; dipping the graphite material and the positive electrode wrapped in the semipermeable membrane and a negative electrode into an acidic electrolyte; conducting a electrolysis process, such that a first graphene oxide having a size larger than a pore size of the semipermeable membrane is exfoliated from the graphite material; continuously conducting the electrolysis process until a second graphene oxide is split from the first graphene oxide, wherein the second graphene oxide has a size which is smaller than the pore size of the semipermeable membrane to penetrate through the semipermeable membrane; collecting the second graphene oxide diffused into the acidic electrolyte outside of the semipermeable membrane; and chemically reducing the second graphene oxide to obtain a graphene.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 shows an apparatus of electrolyzing graphite to form graphene oxide in one embodiment of the disclosure; and

FIG. 2 shows another apparatus of electrolyzing graphite to from graphene oxide in one embodiment of the disclosure.

### DETAILED DESCRIPTION OF THE INVENTION

The following description is of the best-contemplated mode of carrying out the disclosure. This description is made for the purpose of illustrating the general principles of the disclosure and should not be taken in a limiting sense. The scope of the disclosure is the best determined by reference to the appended claims.

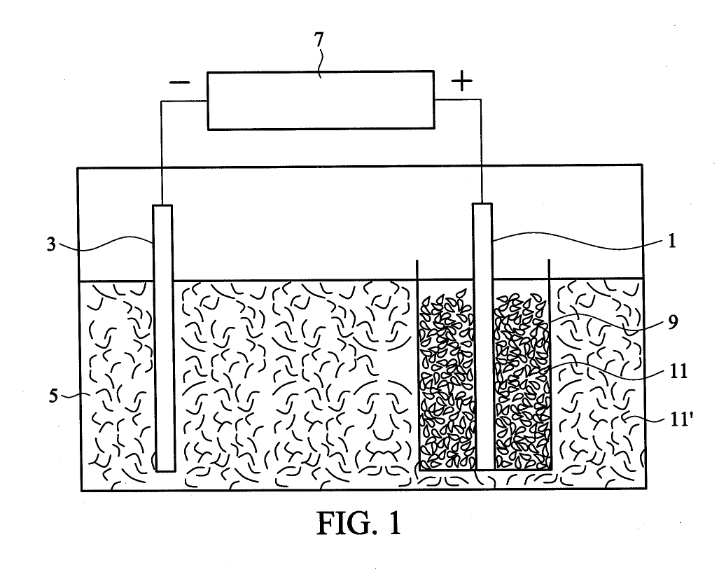

As shown in FIG. 1, graphene can be formed in one embodiment of the disclosure. Firstly, a graphite positive electrode 1 is wrapped in a semipermeable membrane 9. The semipermeable membrane 9 includes an acid resistant polymer such as polyethylene, a polypropylene, a polymethylpentene, or copolymers thereof. The semipermeable membrane 9 has a weight-average molecular weight of 1000 to 6000000. A semipermeable membrane having an overly high weight-average molecular weight will be too hard and too brittle. A semipermeable membrane having an overly low weight-average molecular weight will have weak mechanical strength. The semipermeable membrane 9 has a pore size of 10 nm to 200 nm, which depends on requirement for the final graphene product size. The graphite positive electrode 1 can be a bulk material or a sheet material.

Subsequently, the graphite positive electrode 1 wrapped in the semipermeable membrane 9 and a negative electrode 3 are put into an acidic electrolyte 5. The negative electrode 3, an electrode material not influenced by a chemical reduction in the acidic electrolyte, can be platinum, rhodium, ruthenium, graphite, titanium alloy, or the likes. An acid source of the acidic electrolyte 5 includes acetic acid, hydrochloric acid, sulfuric acid, nitric acid, or other common acids. In one embodiment, the acidic electrolyte 5 has a pH value less than 7.0. In some embodiment, the acidic electrolyte has a pH value of −1 to 6.9. An acidic electrolyte having an overly high pH value easily forms a small-sized graphene with a slower electrolysis rate. On the other hand, an acidic electrolyte having an overly low pH value makes it difficult for a small-sized graphene to be formed.

As shown in FIG. 1, the graphite positive electrode 1 and the negative electrode 3 electrically connect to a direct current power supply 7. The direct current power supply 7 provides a voltage of 1V to 1000V, preferably of 5V to 100V, or more preferably of 5V to 15V. An overly high voltage may cause an overly fast electrolysis rate and an overly large-sized graphene. An overly low voltage may cause low electrolysis efficiency and a slow electrolysis rate.

Subsequently, graphite fragments 11 containing graphene oxide are exfoliated from the graphite positive electrode 1 by electrolysis. Because the graphite fragments 11 containing graphene oxide are larger than the pore size of the semipermeable membrane 9, they are held on the inside of the semipermeable membrane 9 rather than being diffused in the acidic electrolyte 5 at the outside of the semipermeable membrane 9. As such, the graphite fragments 11 containing graphene oxide can be continuously electrolyzed by the voltage from the graphite positive electrode 1 to split into a graphene oxide 11′ with a smaller size. When the graphene oxide 11′ has a size which is smaller than the pore size of the semipermeable membrane 9, the graphene oxide 11′ may penetrate through the semipermeable membrane and diffuse into the acidic electrolyte 5 at the outside of the semipermeable membrane 9. Form a macroscopic view, it is shown that the acidic electrolyte 5 at the outside of the semipermeable membrane 9 gradually appears black, which means that the graphene oxide 11′ is suspended in the acidic electrolyte 5. It should be understood that the concentration of the graphene oxide 11′ in the acidic electrolyte 9 at the outside of the semipermeable membrane 9 should be similar to that in the inside of the semipermeable membrane 9. However, the graphite fragments 11 containing graphene oxide must be kept in the inside of the semipermeable membrane 9 rather than being diffused in the acidic electrolyte 5 at the outside of the semipermeable membrane 5. Accordingly, the graphene oxide 11′ at the outside of the semipermeable membrane 9 must have a size which is less than the pore size of the semipermeable membrane 9.

Thereafter, the graphene oxide 11′ penetrating through the semipermeable membrane 9 and diffusing into the acidic electrolyte 5 is collected. In one embodiment, the graphene oxide 11′ is collected by a filtering-centrifuging process. For example, the acidic electrolyte 5 containing the graphene oxide 11′ can be lead to a filtering device by a pipe (not shown) after electrolysis. The filtered solid includes a little residue and the graphene oxide 11′, and the filtrate is the acidic electrolyte. The filtrate of the acidic electrolyte can be lead to an original electrolysis tank by another pipe (not shown), and an additional acid is replenished to the original electrolysis tank for a next electrolysis procedure to form further graphene oxide 11′. The above processes can be an automatic and controllable continuous process. In addition, additional graphite material (e.g. graphite powder) can be optionally added into the semipermeable membrane 9 to keep the graphene oxide yield of the electrolysis at a desired level. For removing the residue of the filtered solid, the filtered solid can be dissolved in dimethylformamide (DMF) to dissolve the graphene oxide 11′ thereof. The DMF solution is then centrifuged to obtain a supernatant liquid and the residue solid can be separated therefrom. The supernatant liquid is put into a oven to vacuum dry, such that the organic solvent of the supernatant liquid is removed to obtain the graphene oxide 11′. Thereafter, the graphene oxide 11′ is chemically reduced to form graphene. For example, the graphene oxide 11′ can be put into a high temperature furnace under an atmosphere mixture of H₂/Ar (20 sccm/80 sccm) at a temperature of 450° C. for 30 minutes to be reduced to graphene.

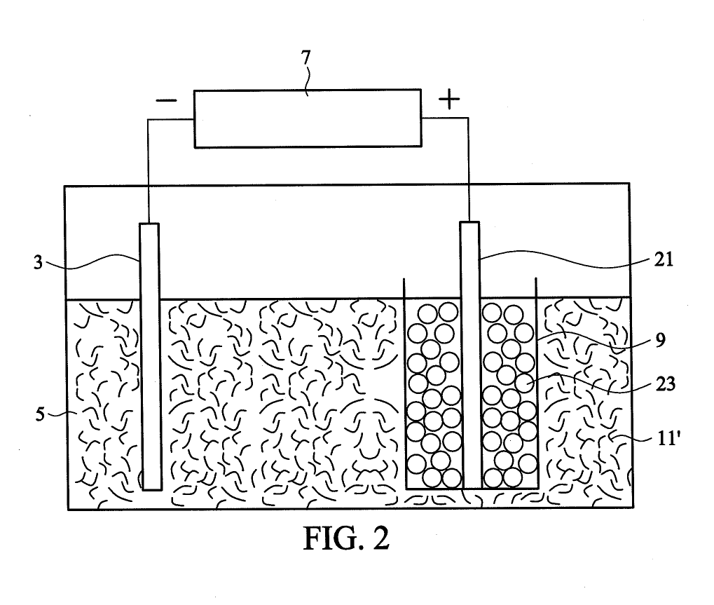

As shown in FIG. 2, a positive electrode 21 and graphite material 23 are wrapped in a semipermeable membrane 9. The semipermeable membrane 9 is similar to that in the described embodiment and therefore omitted here. Similarly, the semipermeable membrane 9 has a pore size of 10 nm to 200 nm, which depends on requirements of the final graphene product size. The positive electrode 21 can be the described graphite positive electrode, and preferably an electrode material which is not influenced or corroded by the acidic electrolyte, such as platinum, rhodium, ruthenium, or gold. The graphite material 23 has a size smaller than that of the described graphite positive electrode to accelerate the electrolysis rate of forming the graphene oxide.

Subsequently, the positive electrode 21 and the graphite material 23 wrapped in the semipermeable membrane 9 and a negative electrode 3 are put into an acidic electrolyte 5. The negative electrode 3 and the acidic electrolyte 5 are similar to that in the described embodiment and therefore omitted here.

As shown in FIG. 2, the positive electrode 21 and the negative electrode 3 electrically connect to a direct current power supply 7. The direct current power supply 7 is similar to that in the described embodiment and therefore omitted here.

Subsequently, graphite fragments (not shown) containing graphene oxide are exfoliated from the graphite material 23 surrounding the positive electrode 21 by electrolysis. Because the graphite fragments containing graphene oxide and the graphite material 23 are larger than the pore size of the semipermeable membrane 9, they are held on the inside of the semipermeable membrane 9 rather than being diffused into the acidic electrolyte 5 at the outside of the semipermeable membrane 9. As such; the graphite fragments containing graphene oxide can be continuously electrolyzed by the voltage from the positive electrode 21 to split into a graphene oxide 11′ with a smaller size. When the graphene oxide 11′ has a size which is smaller than that of the pore size of the semipermeable membrane 9, the graphene oxide 11′ may penetrate through the semipermeable membrane and diffuse into the acidic electrolyte 5 at the outside of the semipermeable membrane 9. From a macroscopic view, the acidic electrolyte 5 at the outside of the semipermeable membrane 9 gradually appears black, which means that the graphene oxide 11′ is suspended in the acidic electrolyte 5. It should be understood that the concentration of the graphene oxide 11′ in the acidic electrolyte 9 at the outside of the semipermeable membrane 9 should be similar to that for the inside the semipermeable membrane 9. However, the larger graphene oxide must be kept on the inside of the semipermeable membrane 9 rather than being diffused into the acidic electrolyte 5 at the outside of the semipermeable membrane 5. Accordingly, the graphene oxide 11′ at the outside of the semipermeable membrane 9 must have a size which is less than the pore size of the semipermeable membrane 9.

Thereafter, the graphene oxide 11′ penetrating through the semipermeable membrane 9 and diffusing into the acidic electrolyte 5 is collected. The graphene oxide 11′ can be collected by a filtering-centrifuging process. Similar to the described embodiment, the acidic electrolyte 5 containing the graphene oxide 11′ can be lead to a filtering device by a pipe (not shown) after electrolysis. The filtered solid includes a little residue and the graphene oxide 11′, and the filtrate is the acidic electrolyte. The filtrate of the acidic electrolyte can be lead to an original electrolysis tank by another pipe (not shown), and an additional acid is replenished to the original electrolysis tank for a next electrolysis procedure to form further graphene oxide 11′. The above processes can be an automatic and controllable continuous process. In addition, additional graphite material (e.g. graphite powder) can be optionally added into the semipermeable membrane 9 to keep the graphene oxide yield of the electrolysis at a desired level. For removing the residue of the filtered solid, the filtered solid can be dissolved in dimethylformamide (DMF) to dissolve the graphene oxide 11′ thereof. The DMF solution is then centrifuged to obtain a supernatant liquid and the residue solid is separated therefrom. The supernatant liquid is put into a oven to vacuum thy, such that the organic solvent of the supernatant liquid is removed to obtain the graphene oxide 11′. Thereafter, the graphene oxide 11′ is chemically reduced to form graphene. For example, the graphene oxide 11′ can be put into a high temperature furnace under an atmosphere mixture of H₂/Ar (20 sccm/80 sccm) at a temperature of 450° C. for 30 minutes to be reduced to graphene.

It should be understood that “the graphene oxide in the acidic electrolyte 5 at the outside of the semipermeable membrane 9 having a size less than the pore size of the semipermeable membrane 9 may filter different sizes of graphene. For example, a positive electrode 21 of platinum and the common graphite material 23 are wrapped in a semipermeable membrane 9 having a pore size of 50 nm to electrolyze, and graphene oxide having a size less than 50 nm diffused into the acidic electrolyte 5 at the outside of the semipermeable membrane 9 is collected. Thereafter, the graphene oxide 11′ and a positive electrode 21 of platinum are wrapped in another semipermeable membrane 9 having a pore size of 40 nm to electrolyze, such that graphene oxide kept in the acidic electrolyte 5 inside of the semipermeable membrane should have a size between 40 nm and 50 nm, and graphene oxide in the acidic electrolyte 5 at the outside of the semipermeable membrane should have a size less than 40 nm. Ex analogia, and combinations of different semipermeable membranes of different pore sizes can be adopted to prepare different graphenes of different sizes.

### EXAMPLES

### Example 1

100 mL of a sulfuric acid solution (0.24M) was prepared as an acidic electrolyte having a pH value of about 0.7. A graphite plate (1.44 g and 20×20×2 mm, commercially available from Central Carbon Co., Ltd.) was wrapped in a semipermeable membrane (single-layered polypropylene with a pore size of 40 nm, commercially available from Celgard) and connected to a positive electrode of a direct current power supply. A platinum wire was connected to a negative electrode of the direct current power supply. Subsequently, the graphite plate wrapped in the semipermeable membrane and the platinum wire were dipped into the acidic electrolyte. A constant voltage of 2.5V was provided by the direct current power supply to process a pre-electrolysis for 1 minute, such that the graphite plate was completely impregnated with the electrolyte. Thereafter, electrolysis was performed at a voltage of 10V for 3 hours. During the electrolysis process, the graphite plate gradually exfoliated and the black solid penetrated through the semipermeable membrane to diffuse to the acidic electrolyte, which was observed. The acidic electrolyte at the outside of the semipermeable membrane was filtered to remove a liquid part thereof. The filtered solid was dissolved in dimethylformamide (DMF) to be supersonic vibrated for 5 minutes. The DMF solution dissolving the graphene oxide was centrifuged by a rotation speed of 2500 rpm for 5 minutes to collect a supernatant liquid thereof. The supernatant liquid baked till dry at a vacuum oven of 190° C. to remove the DMF solvent and obtain the graphene oxide. The graphene oxide was put into a high temperature furnace under an atmosphere mixture of H₂/Ar (20 sccm/80 sccm) at a temperature of 450° C. for 30 minutes. Finally, 0.13 g (yield ˜9%) of graphene having a size less than 40 nm was prepared. The graphene product was analyzed by a Raman spectroscopy. In the Raman spectrum, the graphene characteristic peak (˜2650 cm⁻¹) and the graphite characteristic peak (˜1570 cm⁻¹) had an intensity ratio of about 0.46.

### Example 2

100 mL of a sulfuric acid solution (0.24M) was prepared as an acidic electrolyte having a pH value of about 0.7. Graphite particles (individual diameter of 3 μm, totally 2 g, commercially available from Central Carbon Co., Ltd.) and a platinum wire were wrapped in a semipermeable membrane (single-layered polypropylene with a pore size of 40 nm, commercially available from Celgard), and the platinum wire was connected to a positive electrode of a direct current power supply. Another platinum wire was connected to a negative electrode of the direct current power supply. Subsequently, the graphite particles and the platinum wire wrapped in the semipermeable membrane and the other platinum wire were dipped into the acidic electrolyte. A constant voltage of 2.5V was provided by the direct current power supply to process a pre-electrolysis for 1 minute, such that the graphite particles were completely impregnated with the electrolyte. Thereafter, electrolysis was performed at a voltage of 10V for 3 hours. During the electrolysis process, the graphite particles gradually exfoliated and the black solid penetrated through the semipermeable membrane to diffuse into the acidic electrolyte, which was observed. The acidic electrolyte at the outside of the semipermeable membrane was filtered to remove a liquid part thereof. The filtered solid was dissolved in DMF to be supersonic vibrated for 5 minutes. The DMF solution dissolving the graphene oxide was centrifuged by a rotation speed of 2500 rpm for 5 minutes to collect a supernatant liquid thereof. The supernatant liquid was bake dried at a vacuum oven of 190° C. to remove the DMF solvent and obtain the graphene oxide. The graphene oxide was put into a high temperature furnace under an atmosphere mixture of H₂/Ar (20 sccm/80 sccm) at a temperature of 450° C. for 30 minutes. Finally, 0.08 g (yield ˜4%) of graphene having a size less than 40 nm was prepared. The graphene product was analyzed by a Raman spectroscopy. In the Raman spectrum, the graphene characteristic peak (˜2650 cm⁻¹) and the graphite characteristic peak (˜1570 cm⁻¹) had an intensity ratio of about 0.26.

### Comparative Example 1

100 mL of a sulfuric acid solution (0.24M) was prepared as an acidic electrolyte having a pH value of about 0.7. A graphite plate (1.44 g and 20×20×2 mm, commercially available from Central Carbon Co., Ltd.) was connected to a positive electrode of a direct current power supply. A platinum wire was connected to a negative electrode of the direct current power supply. Subsequently, the graphite plate and the platinum wire were dipped into the acidic electrolyte. A constant voltage of 2.5V was provided by the direct current power supply to process a pre-electrolysis for 1 minute, such that the graphite plate was completely impregnated with the electrolyte. Thereafter, electrolysis was performed at a voltage of 10V for 3 hours. During the electrolysis process, the graphite plate gradually exfoliated to be diffused in the acidic electrolyte, which was observed. The acidic electrolyte was filtered and centrifuged to remove a liquid part thereof. The filtered solid was dissolved in DMF to be supersonic vibrated for 5 minutes. The DMF solution dissolving the graphene oxide was centrifuged by a rotation speed of 2500 rpm for 5 minutes to collect a supernatant liquid thereof. The supernatant liquid baked till dry at a vacuum oven of 190° C. to remove the DMF solvent and obtain the graphene oxide. The graphene oxide was put into a high temperature furnace under an atmosphere mixture of H₂/Ar (20 sccm/80 sccm) at a temperature of 450° C. for 30 minutes. Finally, 0.014 g (yield˜1%) of graphene having a size of 2 nm to 200 nm was prepared. The graphene product was analyzed by a Raman spectroscopy. In the Raman spectrum, the graphene characteristic peak (˜2650 cm⁻¹) and the graphite characteristic peak (−1570 cm⁻¹) had an intensity ratio of about 0.3. The graphene/graphite ratio of product in Comparative Example 1 is obviously less than that in Example 1. It is proven that direct electrolysis without the semipermeable membrane can result in lower yields and an insufficient purity of the graphene.

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of forming graphene, comprising:
wrapping a graphite positive electrode in a semipermeable membrane;
dipping the graphite positive electrode wrapped in the semipermeable membrane and a negative electrode into an acidic electrolyte;
conducting an electrolysis process, such that a first graphene oxide having a size larger than a pore size of the semipermeable membrane is exfoliated from the graphite positive electrode;
continuously conducting the electrolysis process until a second graphene oxide is split from the first graphene oxide, wherein the second graphene oxide has a size which is smaller than the pore size of the semipermeable membrane to penetrate through the semipermeable membrane;
collecting the second graphene oxide diffused into the acidic electrolyte outside of the semipermeable membrane; and
chemically reducing the second graphene oxide to obtain a graphene.

2. The method as claimed in claim 1, wherein the semipermeable membrane comprises an acid resistant polymer.

3. The method as claimed in claim 1, wherein the semipermeable membrane comprises polyethylene, polypropylene, polymethylpentene, or copolymers thereof.

4. The method as claimed in claim 1, wherein the electrolysis process is performed at a voltage of 1V to 1000V.

5. The method as claimed in claim 1, wherein the acidic electrolyte has a pH value of less than 7.0.

6. The method as claimed in claim 1, wherein the step of collecting the second graphene oxide diffused into the acidic electrolyte outside of the semipermeable membrane comprises:
filtering a mixture of the acidic electrolyte and the second graphene oxide to obtain a filtered matter;
dissolving the filtered matter in an organic solvent to form a solution;
solid-liquid separating the solution to remove a solid in the solution; and
removing the organic solvent of the solution to obtain the second graphene oxide.

7. A method of forming graphene, comprising:
wrapping a graphite material and a positive electrode in a semipermeable membrane;
dipping the graphite material and the positive electrode wrapped in the semipermeable membrane and a negative electrode into an acidic electrolyte;
conducting an electrolysis process, such that a first graphene oxide having a size larger than a pore size of the semipermeable membrane is exfoliated from the graphite material;
continuously conducting the electrolysis process until a second graphene oxide is split from the first graphene oxide, wherein the second graphene oxide has a size which is smaller than the pore size of the semipermeable membrane to penetrate through the semipermeable membrane;
collecting the second graphene oxide diffused into the acidic electrolyte outside of the semipermeable membrane; and
chemically reducing the second graphene oxide to obtain a graphene.

8. The method as claimed in claim 7, wherein the semipermeable membrane comprises an acid resistant polymer.

9. The method as claimed in claim 7, wherein the semipermeable membrane comprises polyethylene, polypropylene, polymethylpentene, or copolymers thereof.

10. The method as claimed in claim 7, wherein the positive electrode comprises platinum, ruthenium, rhodium, or gold.

11. The method as claimed in claim 7, wherein the electrolysis process is performed at a voltage of 1V to 1000V.

12. The method as claimed in claim 7, wherein the acidic electrolyte has a pH value of less than 7.0.

13. The method as claimed in claim 7, wherein the step of collecting the second graphene oxide diffused into the acidic electrolyte outside of the semipermeable membrane comprises:
filtering a mixture of the acidic electrolyte and the second graphene oxide to obtain a filtered matter;
dissolving the filtered matter in an organic solvent to form a solution;
solid-liquid separating the solution to remove a solid in the solution; and
removing the organic solvent of the solution to obtain the second graphene oxide.
